(19) United States
(12) Patent Application Publication
(10) Pub. No.: US 2004/0156204 A1
(43) Pub. Date: Aug. 12, 2004

(54) Full cutoff high-mounted outdoor lighting system

(76) Inventor: Alex Francisco Galia, Glendale, AZ (US)

Correspondence Address: Steven Thrasher, 391 Sandhill Dr., Richardson, TX, 75080, US

(21) Appl. No.: 10/775,369

(22) Filed: Feb. 10, 2004

Related U.S. Application Data
(63) Continuation-in-part of application No. 09/921,800, filed on Aug. 6, 2001.

(51) Int. Cl. F21S 8/00

(52) U.S. Cl. 362/431; 362/249; 362/145

(57) ABSTRACT

The invention is an illumination assembly for illuminating a large outdoor playing field with zero candela intensity at an angle of ninety degrees above nadir, via full cutoff luminaries and full cutoff luminary assemblies. The invention also contemplates the business method associated with marketing the inventive apparatus.

### CROSS-REFERENCE TO RELATED APPLICATION

The present invention is a continuation in part of, is related to, and claims priority from co-pending U.S. patent application Ser. No. 09/921,800 entitled FULL CUTOFF HIGH-MOUNTED OUTDOOR LIGHTING SYSTEM to Galia, filed on 6 Aug. 2001.

### TECHNICAL FIELD

Generally, the invention relates to the field of illumination, and, more specifically, the invention relates to systems, methods, and devices for illuminating outdoor playing fields.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Since the early days of night baseball, outdoor lighting has allowed persons to enjoy leisure activities in the evening. Nighttime sporting events have been of particular benefit for those persons who once had to pursue these activities in the heat of a summer sun. However, the use of outdoor lighting at sporting events, concerts and other activities has raised several criticisms.

One of the criticisms mounted against outdoor lighting centers on the amount of glare (also called “spill” or “light pollution”) from outdoor lighting. This particularly raises complanets where residents close to the lights and wish to sleep before the lights are turned off. Also, the glare is obtrusive to drivers who view the glare where lit fields are close to roadways.

Accordingly, to overcome these and other disadvantages associated with existing methods of lighting sports fields, it would be advantageous to provide means for reducing the cost and energy consumption associated with the operation and installation of outdoor lighting, and for reducing the glare and spill associated with outdoor lighting.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows a mounting of an illumination assembly that provides emphasis to referenced angles;

FIG. 2 illustrates an illumination assembly having a first luminary and a second luminary to show various cutoff angles;

FIG. 3 is a top-view of a full cutoff luminary; and

FIG. 4 is a side-view of a modified full cutoff illumination assembly having a plurality of luminaries;

FIG. 5a shows a multi-luminary illumination assembly; and

FIG. 5b illustrates a multi-lamp luminary.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the claims section. The invention is also described in view of the Festo decisions, and, in that regard, the claims and the invention incorporate equivalents known, foreseeable, and unforeseeable. However, it is not desired that the invention be interpreted according to Festo, and, in this regard, to the fullest extent permissible, the invention is expressly intended to be interpreted to the fullest extent permissible under the doctrine of equivalents.

Description of the Figures

A full cutoff outdoor lamp is defined herein as providing a light intensity distribution of a luminaire light distribution where aero candela intensity occurs at an angle of 90-degrees above nadir, and at all angles greater than nadir. Additionally, the candela per 1000 lamp lumens does not numerically exceed 10% at a vertical angle above nadir. This applies to all lateral angles around the luminaire. Cutoff, semi-cutoff, and non-cutoff systems are known and described in detail in various trade publications by the Illuminating Engineering Society of North America.

The use of full cutoff lighting in provides the previously unknown technical advantages in the art of outdoor playing field illuminations by reducing the number of supports required to provide complete lighting to a field, relative to other low-glare systems, thus lowering installation costs and operational costs. Contrary to various prior art assumptions, the dramatic reduction of glare actually enhances the quality of the sports performance. Accordingly, the invention provides an illumination assembly for illuminating a large outdoor playing field with zero candela intensity at an angle of ninety degrees above nadir by using full cutoff luminaries. Thus, the invention may be definable as a lighting system for illuminating a large outdoor playing field with full cutoff lighting, using a plurality of full cutoff illumination assemblies placed in predetermined locations about the playing field.

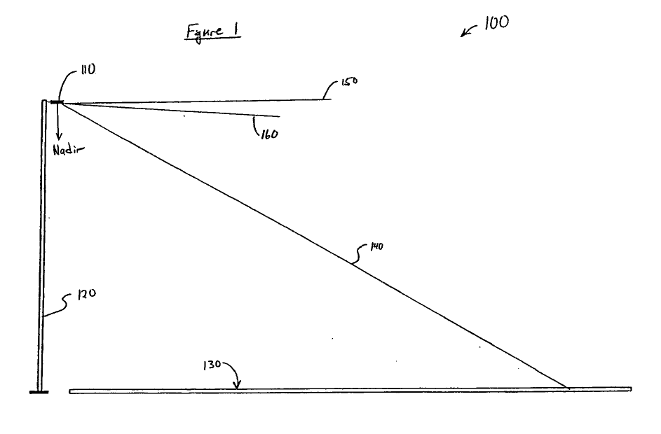

FIG. 1 shows a mounting of an illumination assembly 100 that provides emphasis to referenced angles. In general, the illumination assembly 100 provides a full cutoff luminary 110 coupled to a support 120. The support 120 may be any supporting means such as a pole, a building, or another structure. Preferably, the luminary is mounted at about 40 feet, but could be mounted between about 40 feet and up to a height of about 120 feet, and as high as about 160 feet above a target area, for example, when lighting large sports fields such as those in excess of 4000 square years in area. The full cutoff luminary 110 maintains at least one lamp (not shown in FIG. 1) that produces light and throws the light upon a target area 130. The target area is preferably a playing field. Preferably, the illumination assembly is configurable to light a playing field such as a football field, a soccer field, a baseball field or a softball field (sometimes collectively referred to as “ball fields”), by being placed about the periphery of the playing field. To light a typical playing field, it will take a plurality of illumination assemblies mounted about the periphery of the playing field. Upon reading the present disclosure, the placement of such assemblies about a playing field will be readily apparent to those of ordinary skill in the art.

Nadir is the angle of 0-degrees directly below the luminaire. The horizontal plane of the luminaire is 90-degrees, which is also 90-degrees above nadir. The nature of the full cutoff luminary is such that the full cutoff luminary has a light distribution that produces a zero candela intensity at an angle of 90 degrees above nadir, which is illustrated by the horizontal line 150 (also called the horizontal plane), and the candela per 1000 lamp lumens does not exceed 100 (or, 10%) at a vertical angle of 80 degrees above nadir (this applies to all lateral angles around the luminary). The luminary is also preferably a shoebox-style luminary, which is known in the lighting arts, but not known in the full cutoff playing field lighting arts. Preferably, an improved full cutoff luminary produces zero candela intensity at even an angle of 85 degrees above nadir, which is illustrated by the preferred cutoff line 160. In one embodiment, the invention cast the main beam intensity below the 65-degree plane 140.

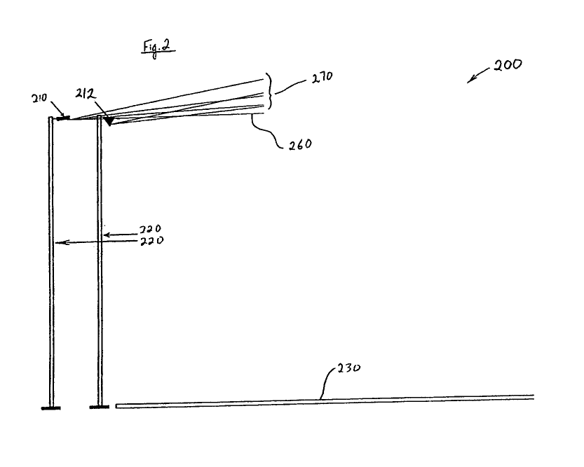

Appreciation of the invention can be realized by examining poor light casting. FIG. 2 illustrates lamp assemblies 200 having a first luminary 210 and a second luminary 212 to show various cutoff angles. In FIG. 2 it is shown that the luminaries 210, 212 throw light above a horizontal plane 260. This is considered cutoff lighting, in that lamp light distribution has candela per 1000 lamp lumens that does not exceed 25 (2.5%) at an angle of 90 degrees above nadir, and 100 (10%) at a vertical angle of 80 degrees above nadir. This applies to lateral angles around the luminary. One disadvantage of cutoff luminaries is that they still produce glare and spill light due to the casting of light above the horizontal plane. The luminaries 210, 212, which may be floodlights, may be improperly mounted full cutoff luminaries.

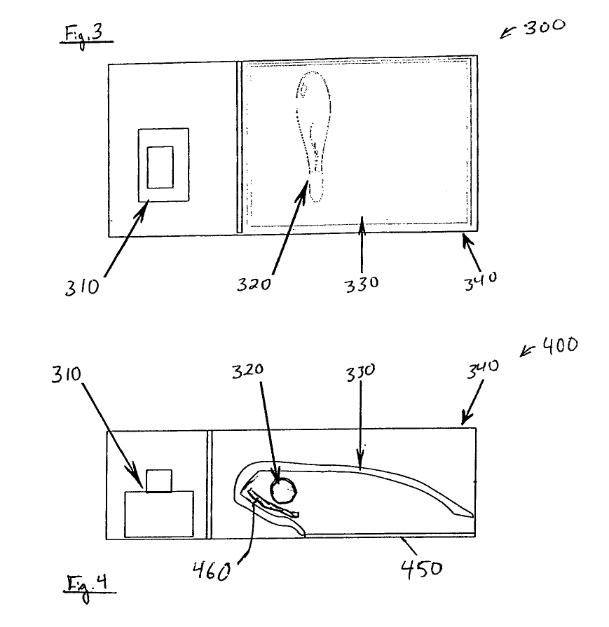

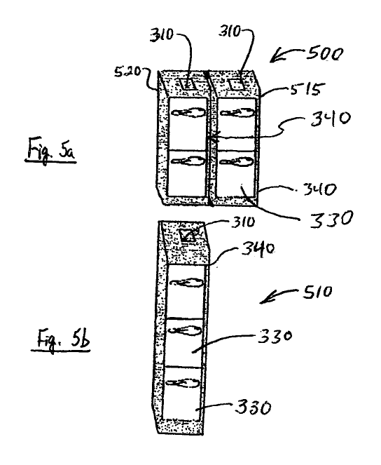

Implementation of a full cutoff illumination assembly is preferably achieved with full cutoff luminaries. FIG. 3 is a top-view of a full cutoff luminary 300, while FIG. 4 is a side-view of a modified full cutoff illumination assembly 400 having a plurality of luminaries. FIGS. 5a and 5b each illustrate two embodiments of multi-lamp luminaries, while FIG. 5a in particular shows a multi-luminary illumination assembly. Each of the devices 300, 400, 500, 510 is preferably coupled to a support via a support-receiving portion, and, as shown, more than one luminary may be coupled to a single support.

The full cutoff luminary 300 and the modified illumination assembly 400 each show an included a ballast/transformer 310 for converting power in a support to the type of power needed by a lamp 320. Preferred lamps include metal halide lamps, high-pressure sodium lamps, or light-emitting diodes (LEDs), for example. In addition, each of the devices 300, 400, 500, 510 provides a lamp housing 340 with a lens 450 mounted thereto. The lamp housing is preferably sufficiently deep to allow a lamp to cast light at full cut-off angles, meaning that the lamp housing is at least as deep as the relevant lamp dimension (the lamp dimension that may protrude from the housing when the lamp is installed; the lamp radius in FIG. 4), and is preferably at least twice as deep as the relative lamp dimension. Upon reading the present disclosure, alternative configurations are readily apparent to those of ordinary skill in the illumination arts.

A reflector 330 is a preferred means for casting light in a desired location of a target area and for prohibiting the casting of light behind the assembly. In a preferred embodiment, a modified illumination device 500 includes a second luminary 520 mounted behind a first luminary 515 within the same illumination assembly 500. Furthermore, referring again to FIG. 4, in a preferred embodiment, the invention provides a light-blocking shield (back-light shielding) 460 as a preferred means for preventing spill light and glare. A similar light-blocking effect can also be achieved with skirting or panels mounted or placed behind the luminaire.

The lamps of the devices 300, 400, 500, 510 preferably have a main candle power distribution in about the sixty-degree plane, and do not emit light above the eighty-five degree plane. This allows the luminaries to be coupled to the support at an angle above the horizontal plane. In addition, the devices 300, 400, 500, 510 maintain a main beam intensity in about the sixty-degree plane.

FIG. 5a shows a multi-luminary illumination assembly 510. The multi-luminary illumination assembly 510 has a first luminary 515 and a second luminary 520 disposed adjacent to the first luminary 515. Although two luminaries 515, 520 are illustrated, it should be understood that any number of luminaries may be disposed adjacent to each other, in a side-by-side fashion, one above the other, or diagonally across from each other.

FIG. 5b illustrates a multi-lamp luminary 510. The multi-lamp luminary 510 has three lamps disposed vertically one above the other. Although three lamps are illustrated, it should be understood that any number of lamp may be disposed in any configuration, and in conjunction with reflectors and/or light blocking shields to achieve a desired light distribution. In preferred embodiments, a plurality of luminaries is located in approximately the same horizontal plane on a single support pole or other support structure. Alternatively, a single large luminary housing comprising multiple optical assemblies or light emitting devices is located at approximately the same vertical height (approximately in the same horizontal plane) on a support pole or other structure.

In yet another alternative embodiment, additional luminaries may be mounted on a support pole or structure, where each luminaire is “aimed” to achieve overall system (assembly) full cutoff. This is made possible by arranging the lamps “front-to-back” rather than “side-by-side.” In a preferred embodiment, this is achieved with a single mounting arm (not shown, but understood in the outdoor lighting arts). Such re-arrangement is readily understood by those skilled in the art, and goes against the accepted arrangement of lamps in the art. This allows for side-by-side mounting of luminaire assemblies on approximately the same horizontal plane, while lowering the need for additional support structures. In this assembly configuration, the vertical distance between luminaries should be no less than nine feet and no more than sixty feet to achieve desired optical effects. One advantage of a multi-level arrangement of luminaire assemblies is that by aiming the light, fewer poles are needed to utilize full cutoff assemblies in playing fields than in prior art non full cutoff systems. Interestingly, this configuration allows one to achieve full cutoff with even standard cutoff forward-throw, single optical assembly luminaires (a standard cutoff lamp assembly is not full cutoff, by definition).

Also preferably, the optical assembly emits light with a main candela intensity distribution in a vertical angle of 65-degrees above nadir when measured at a lateral angle of 0-degrees. Preferably, in all lateral angles the optical assembly emits less than 10% candela intensity at a vertical angle of 80-degrees above nadir. In addition, it is preferable that in all lateral angles the optical assembly emits 0 candela intensity at 90-degrees and all angles greater than 90-degrees above nadir.

The invention may be embodied as methods of lamp assembly installation, and may include acts that promote the business of lamp assembly installation. For example, one method may incorporate the promotion of full cutoff lamp assemblies. Another method contemplates coordination with a local government or other organizations to show compliance with a light (or dark sky) ordinance. Preferably, the methods include installing the lamp assemblies about a sports field, and may incorporate the use of computing equipment to coordinate public support and feedback for placement of the invention.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A lighting system for illuminating a large outdoor playing field, comprising:
a playing field;
a plurality of full cutoff illumination assemblies placed in predetermined locations about the playing field, each illumination assembly comprising a support and a full cutoff luminary coupled to the support;
each full cutoff luminary comprising
a lamp housing that encloses a lamp, the lamp housing having an open end,
a lamp lens mounted upon the open end of the lamp housing,
a reflector disposed between the lap and the lamp housing, and
a light-blocking shield coupled about the open end of the lamp housing;
wherein each full cutoff luminary achieves full cutoff, zero candela intensity at an angle of ninety degrees above nadir; and
wherein each full cutoff luminary is coupled to a support such that the plurality of illumination assemblies, when placed in the predetermined locations, also achieves full cutoff.

2. The lighting system of claim 1 wherein the outdoor playing field comprises a football field.

3 The lighting system of claim 1 wherein the illumination assemblies comprise a plurality of luminaries.

4. The lighting system of claim 1 wherein a first luminary is mounted behind a second luminary as a single luminary assembly.

5. The lighting system of claim 1 wherein each luminary is mounted at a height of at least 40 feet.

6. A method of reducing light pollution in an outdoor environment and for facilitating compliance with local lighting ordinances, comprising:
removing all non-full cutoff luminaries that once lit a playing field from the playing field; and then
mounting at least one full cutoff luminary about the playing field, the full cutoff luminary comprising
a lamp housing that encloses a lamp, the lamp housing having an open end,
a lamp lens mounted upon the open end of the lamp housing,
a reflector disposed between the lap and the lamp housing, and
a light-blocking shield coupled about the open end of the lamp housing.

7. The method of claim 6 further comprising turning on a full cutoff luminary.

8. The method of claim 6 further comprising the act of automatically registering with a local government to show compliance with a local light ordinance via a computing machine.

9. The method of claim 8 further comprising the act of automatically canvassing a local community to educate the residents that that installation of full cutoff lighting will dramatically reduce spill light.

10. An illumination assembly for illuminating a large outdoor playing field with zero candela intensity at an angle of ninety degrees above nadir, comprising:
a support-receiving portion;
a full cutoff luminary coupled to the support;
the full cutoff luminary comprising
a lamp housing that encloses a lamp, the lamp housing having an open end,
a lamp lens mounted upon the open end of the lamp housing,
a reflector disposed between the lap and the lamp housing, and
a light-blocking shield coupled about the open end of the lamp housing; and
wherein each full cutoff luminary is coupled to the support in a way that the illumination assembly itself achieves full cutoff.

12. The illumination assembly of claim 14 wherein the luminary comprises a lamp having a main candle power distribution in about the sixty-degree plane.

13. The illumination assembly of claim 15 wherein the luminary does not emit light above the eighty-five degree plane.

14. The illumination assembly of claim 15 wherein the luminary maintains a main beam intensity in the sixty-degree plane.

15. The illumination assembly of claim 15 wherein the luminary is coupled to the support at an angle above the horizontal plane.

16. The illumination assembly of claim 14 further comprising a second luminary coupled to the support.

17. The illumination assembly of claim 10 wherein the illumination assembly comprises a plurality of luminaries.
